(19) United States
(12) Patent Application Publication
(10) Pub. No.: US 2010/0194123 A1
(43) Pub. Date: Aug. 5, 2010

(54) Window lock

(76) Inventor: Wan-Lai Liau, Taipei (TW)

Correspondence Address: Jackson Intellectual Property Group PLLC, 106 Starvale Lane, Shipman, VA, 22971, US

(21) Appl. No.: 11/984,997

(22) Filed: Nov. 26, 2007

(51) Int. Cl. E05C 3/14

(52) U.S. Cl. 292/242

(57) ABSTRACT

A window lock is composed of a base and a rotating element. When a force-exertion part of the rotating element is exerted with force to rotate clockwise or counterclockwise by an angle with a central shaft as an axis, a camshaft rotates with the rotating element synchronously, allowing two convex parts to be abutted respectively on inner surfaces of first and second elastic spring leaves, and the first and second elastic spring leaves to be expanded elastically. When the two convex parts are escaped from the inner surfaces of the first and second elastic spring leaves, the first and second elastic spring leaves are restored elastically.

Therefore, the rotating element can have an excellent elastic movement upon rotating by an angle, and there will be no concern of elastic fatigue or loosening if the lock is used for a long time by rotating.

### BACKGROUND OF THE INVENTION

a) Field of the Invention

The present invention relates to a window lock, and more particularly to a window lock which is a rotating element provided with an ear member, such that when the lock rotates to displace, an excellent elastic positioning can be available, without resulting in an elastic fatigue or getting loosened under a long term of usage by rotating.

b) Description of the Prior Art

A conventional window lock is disclosed as a typical example in the Taiwan Patent Publication No. 189021, wherein a rotating element in an ear shape is described. When the rotating element rotates, it will link a camshaft through a shaft, and a surface of the camshaft is provided with concaved parts and convex parts. A U-shape spring wire is locked into a circumferential surface of the camshaft, such that when the camshaft is rotated, its convex parts can butt off the spring wire, allowing the ear-shape rotating element to have an elastic force of rotation. When the camshaft is further rotated by an angle, the U-shape spring wire will be restored with respect to the concaved parts of the camshaft. The object of this prior art is to provide the rotating element with the elastic positioning upon rotating, such that a rotational stability of the rotating element can be increased, and a rotating hook can be locked into a slot reliably.

Yet, under a long term of usage, the prior art is provided with several shortcomings. As the spring wire enables the concaved parts and the convex parts of the camshaft to operate for a long time, an elastic fatigue will be resulted very easily. On the other hand, loosening between the rotating element and other parts will cause a rotating circumference of the rotating element to be unstable, which results in that the hook will be difficult to be locked into the slot.

### SUMMARY OF THE INVENTION

The primary object of the present invention is to provide a window lock, which is provided with an excellent elastic movement when a rotating element rotates by an angle, such that there will be no concern of an elastic fatigue or loosening under a long term of usage by rotating.

Another object of the present invention is to provide a window lock, wherein a circumferential track of a rotating element will be stable under a long term of rotation, such that an arc-shape chimb can be successfully locked into a lock for a long time.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an exploded view of parts of the present invention.

FIG. 2 shows a perspective view of the present invention, after being assembled.

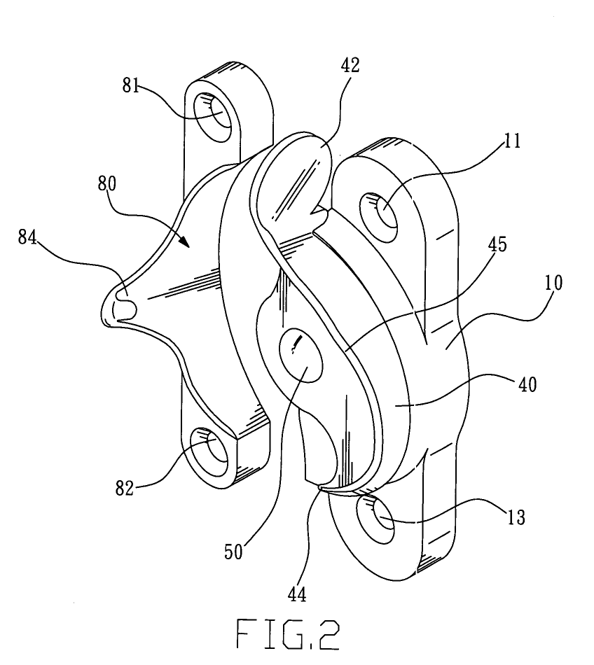

FIG. 3 shows a first rear view of an operation of the present invention.

FIG. 4 shows a second rear view of an operation of the present invention.

FIG. 5 shows a third rear view of an operation of the present invention.

FIG. 6 shows a local perspective view of an embodiment of the present invention.

### DETAILED DESCRIPTION OF THE PREFERRED EMBODIMENTS

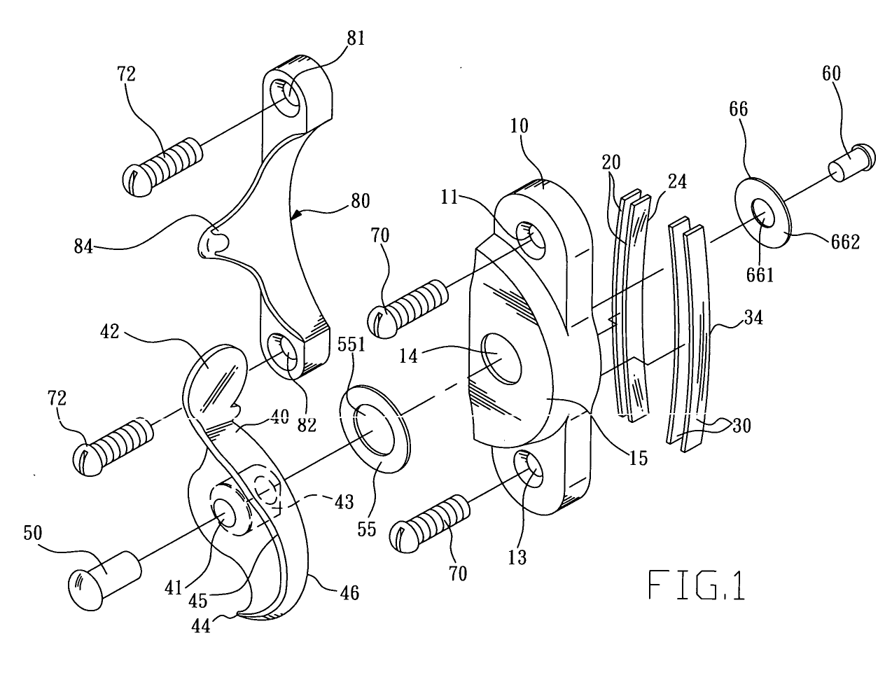

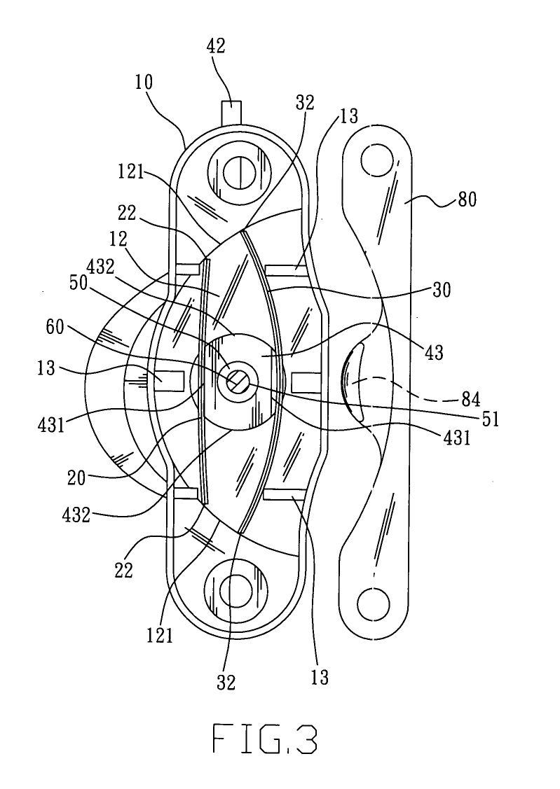

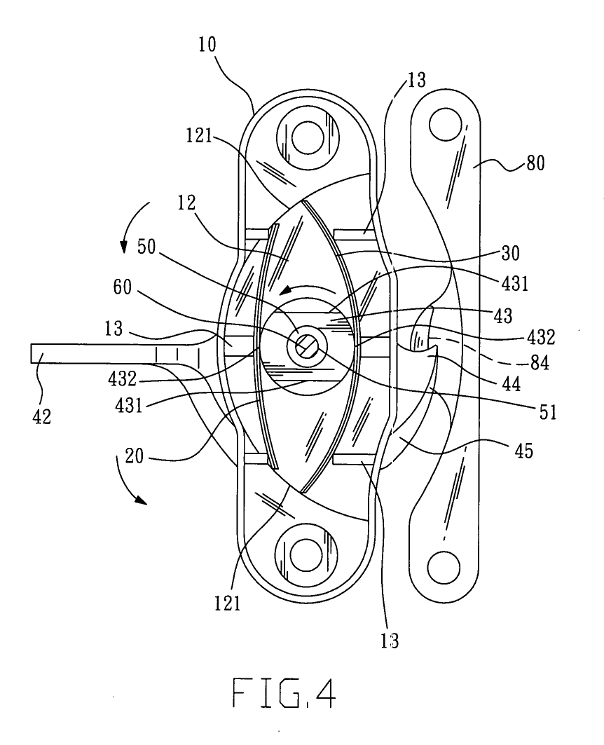

Referring to FIG. 1, the present invention includes a base 10, an interior of which is provided with a groove 12 (as shown in FIG. 3), with a bottom of the groove 12 being disposed with a through-hole 14, a periphery of the groove 12 being disposed with a locking interface 121, and an interior of the groove 12 being locked with first and second elastic spring leaves 20, 30 that are located respectively at two sides of the through-hole; a rotating element 40, a body of which is disposed with a central shaft hole 41, an upper end of which is formed with a force-exertion part 42 with an arc-shape chimb 45 being formed along a lower side of the force-exertion part 42, and an inner side of which is transversally fixed with a camshaft 43 with an outer surface of the camshaft 43 being provided respectively with concaved parts 431 and convex parts 432 (as shown in FIG. 3); a central shaft 50, which is transfixed into the shaft hole 41, and the through-hole 14 of the base 10, so as to be fixed on the base 10. When the force-exertion part 42 of the rotating element 40 is exerted by force to rotate the rotating element 40 clockwise or counterclockwise by an angle with the central shaft 50 as an axis, the camshaft 43 will rotate synchronously with the rotating element 40, and the two convex parts 432 will be abutted respectively on inner surfaces of the first and second elastic spring leaves 20, 30, allowing the first and second elastic spring leaves 20, 30 to be elastically expanded (as shown in FIG. 4). When the two convex parts 432 are escaped from the inner surfaces of the first arid second elastic spring leaves 20, 30, the first and second elastic spring leaves 20, 30 will be restored elastically (as shown in FIG. 3).

Referring to FIG. 3 and FIG. 4, two end parts 22 of each of the first elastic spring leaves 20 are abutted respectively on the locking interface 121, and two end parts 32 of each of the second elastic spring leaves 30 are abutted respectively on the locking interface 121.

Referring to FIG. 1 and FIG. 3, an end surface of the central shaft 50 is provided with a connecting hole 51, and a rivet 60 is transfixed into a central through-hole 661 of a washer 66 and is further transfixed into the connecting hole 51. A surface 662 of the washer 66 is abutted at side edges 24, 34 of the first and second elastic spring leaves 20, 30, such that the first and second elastic spring leaves 20, 30 can be stably emplaced into the groove 12.

Referring to FIG. 3 and FIG. 4, there are two first elastic spring leaves 20, which are overlapped in the groove 12; and there are also two second elastic spring leaves 30, which are overlapped in the groove 12.

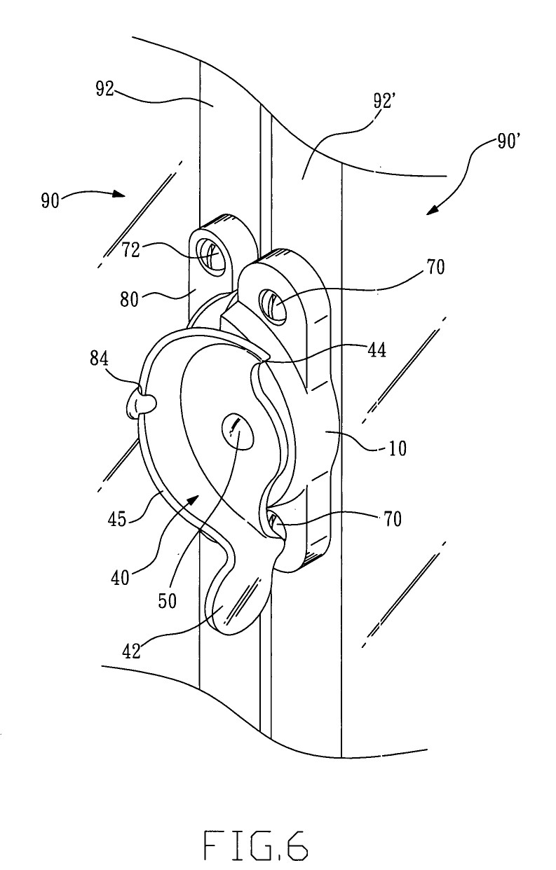

Referring to FIG. 1 and FIG. 6, an upper and a lower end of the base 10 are provided respectively with connecting holes 11, 13, and bolts 70 are transfixed respectively into the connecting holes 11, 13 and are screwed on a side surface 92′ of a right window 90′. There is also an internal seat 80, a top and a bottom end of which are provided respectively with connecting holes 81, 82, and a side end of which is provided with a slot 84. Bolts 72 are transfixed respectively into the connecting holes 81, 82, and are screwed on a side surface 92 of a left window 90 (as shown in FIG. 6). If the rotating element 40 rotates clockwise or counterclockwise to displace, then the arc-shape chimb 45 can be locked into or escaped from the slot 84.

Referring to FIG. 1, a lower end of the rotating element 40 is formed with a tip part 44, a width of which is gradually increased upward to form the arc-shape chimb 45.

Referring to FIG. 3 and FIG. 4, the locking interface 121 is an arc-shape straight wall to define a boundary of 1:he slot 12.

Referring to FIG. 3 and FIG. 4, the convex parts 432 are arc-shape surfaces, and the concaved parts 431 are flat surfaces.

Referring to FIG. 3 and FIG. 4, a plurality of ribs 13 are protruded along a peripheral edge of the locking interface 121. Referring to FIG. 1, a side surface 46 of the rotating element 40 is latched with a washer 55 which is provided with a central hole 551 being located at an exterior space of the camshaft 43.

Referring to FIG. 6, when the right window 90′ and the left window 90 are closed with respect to each other, the rotating element 40 is closest to the slot 84 of the internal seat 80.

Referring to FIG. 3, it shows a bottom view of the rotating element 40 before rotating to displace. When a human hand grabs the force-exertion part 42 and rotates it clockwise, the two end parts 22, 32 of the first and second elastic spring leaves 20, 30 will be locked respectively on a surface of the locking interface 121, and the two concaved parts 431 will be in a vertical state without contacting the first and second elastic spring leaves 20, 30.

Referring to FIG. 4, when the force-exertion part 42 of the rotating element 40 is grabbed by human fingers to rotate to a horizontal position, the two convex parts 432 will be rolling to be abutted on inner surfaces of the first and second elastic spring leaves 20, 30 respectively, allowing the first and second elastic spring leaves 20, 30 to be elastically expanded outward, respectively. The design of the plurality of ribs 13 is to abut, position, and prevent the first and second elastic spring leaves 20, 30 from being excessively deformed or off-displaced. As a result, FIG. 4 refers to a condition that elastic tensions of the first and second elastic spring leaves are at maximum values, and a torque of the rotating element 40 is at a maximum value. At this time, the tip part 44 will gradually pass through a bottom of the slot 84, and as an area and a thickness of the tip part 44 are smaller, the tip part 44 will not be located in the slot 84, and the arc-shape chimb 45 will be widen (thicken) gradually, further allowing the arc-shape chimb 45, which is rotating to displace, to gradually approach to an interior of the slot 84.

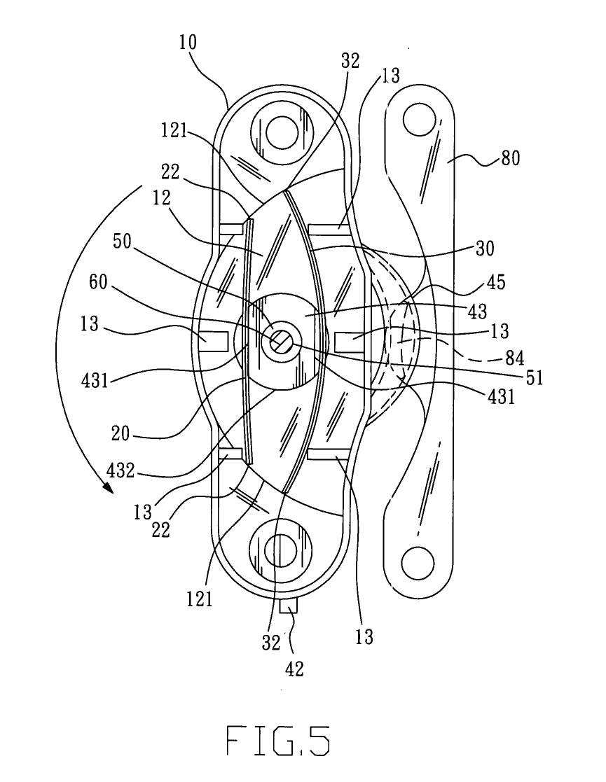

Referring to FIG. 5, when the force-extension part 42 is moved counterclockwise to a lower dead point, the camshaft 43 will rotate to displace synchronously, allowing the two convex parts 432 to be escaped from the first and second elastic spring leaves 20, 30, respectively. The first and second elastic spring leaves 20, 30 will be restored elastically, and a widest position of the arc-shape chimb 45 will be completely locked into the slot 84, such that the right and left windows 90′, 90 can be locked with respect to each other (as shown in FIG. 6).

According to FIG. 5, when the force-exertion part 42 is further moved to rotate counterclockwise, similarly, the convex parts 432 will again be rolling to be abutted on the inner surfaces of the first and second elastic spring leaves 20, 30, allowing the first and second elastic spring leaves 20, 30 to be elastically expanded outward once more. At this time, the torque value will be the maximum, and the arc-shape chimb 45 with the larger width will rotate to be escaped from the slot 84, allowing the tip part 44 to be located below a side of the slot 84 (as shown in FIG. 4). Next, the force-exertion part 42 is moved to an upper dead point, as shown in FIG. 3, the first and second elastic spring leaves 20, 30 will be restored, and then the tip part 44 will be escaped from the slot 84 (not shown in FIG. 3). At this time, the locking state of the right and left windows 90′, 90 disappears, and the right and left windows 90′, 90 can be opened with respect to each other (not shown on the drawing).

Referring to FIG. 1, the rivet 60 is fixed into the central shaft 50, and is assembled with the central shaft 50 to form an integral body, which further allows the washer 66 to be tightened on the side edges 24, 34 of the first and second elastic spring leaves 20, 30, such that the first and second elastic spring leaves 20, 30 can be firmly positioned. In a mean time, the rivet 60 is fixed on the central shaft 50, allowing the rotating element 40 to rotate on the base 10 for a long time, without resulting in loosening or gaps, thereby further enabling the rotating element 40 to rotate in an arc line with the central shaft 50 as an axis for a long time. Therefore, a reliability of firmly fixing the arc-shape chimb 45 into the slot 84 can be increased.

The washer 55 serves as a rotating interface for the rotating element 40 and the base 10, and when the rotating element 40 rotates, the washer 55 will rotate synchronously along with ‘the rotating element 40, such that an exterior surface of the washer 55 can be slidingly displaced on an exterior sliding surface 15 of the base 10.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A window lock comprising:
a base, an interior of which is provided with a groove, with a bottom of the groove being disposed with a through-hole, a periphery of the groove being disposed with a locking interface, and an exterior of the groove being locked with first and second elastic spring leaves that are located respectively, at two sides of the through-hole;
a rotating element, a body of which is provided with a central shaft hole, a top end of which is formed with a force-exertion part, with an arc-shape chimb being formed along a lower side of the force-exertion part, and an inner side of which is transversally fixed with a camshaft, with an outer surface of the camshaft being provided respectively with concaved parts and convex parts;
a central shaft, which is transfixed into the shaft hole, and the through-hole of the base, so as to be fixed on the base;
when the force-exertion part of the rotating element being exerted with force to rotate the rotating element clockwise or counterclockwise by an angle with the central shaft as an axis, the camshaft rotating with the rotating element synchronously, allowing the two convex parts to be abutted respectively on inner surfaces of the first and second elastic spring leaves, and the first and second elastic spring leaves to be expanded elastically;
when the two convex parts being escaped from the inner surfaces of the first and second elastic spring leaves, the first and second elastic spring leaves being restored elastically.

2. The window lock according to claim 1, wherein two end parts of each of the first elastic spring leaves are abutted respectively on the locking interface, and two end parts of each of the second elastic spring leaves are abutted respectively on the locking interface.

3. The window lock according to claim 1, wherein an end surface of the central shaft is provided with a connecting hole; a rivet being transfixed into a central through-hole of a washer, and further transfixed into the connecting hole; a surface of the washer being abutted on side edges of the first and second elastic spring leaves to stably emplace the first and second elastic spring leaves into the groove.

4. The window lock according to claim 1, wherein there are two first elastic spring leaves which are overlapped in the groove, and there are two second elastic spring leaves which are overlapped in the groove.

5. The window lock according to claim 1 wherein an upper and a lower end of the base are provided respectively with a connecting hole; bolts being transfixed respectively into the connecting holes, and being screwed on a side surface of a right window; an internal seat being provided, with an upper and a lower end of the internal seat being provided respectively with a connecting hole, and a side end of the internal seat being provided with a slot; bolts being transfixed respectively into the connecting holes, and being screwed on a side surface of a left window; when the rotating element rotating to displace clockwise or counterclockwise, the arc-shape chimb being locked into or escaped from the slot.

6. The window lock according to claim 1, wherein a bottom end of the rotating element is formed with a tip part, with a width of which being gradually increased upward, to form the arc-shape chimb.

7. The window lock according to claim 1, wherein the locking interface is an arc-shape straight wall to define a boundary of the groove.

8. The window lock according to claim 1, wherein the convex parts are arc-shape surfaces, and the concaved parts are flat surfaces.

9. The window lock according to claim 1, wherein a plurality of ribs are protruded along a peripheral edge of the locking interface.

10. The window lock according to claim 1, wherein a side surface of the rotating element is latched with a washer which is provided with a central hole being located at an exterior space of the camshaft.
